(19) United States
(12) Patent Application Publication
(10) Pub. No.: US 2020/0094777 A1
(43) Pub. Date: Mar. 26, 2020

(54) ACCESS AND/OR STARTING DEVICE FOR A VEHICLE

(71) Applicant: Continental Automotive GmbH, Hannover (DE)

(72) Inventor: Alexander HEINRICH, Donaustauf (DE)

(21) Appl. No.: 16/469,025

(22) PCT Filed: Dec. 12, 2017
(86) PCT No.: PCT/EP2017/082411

§ 371 Date: Jun. 12, 2019

(30) Foreign Application Priority Data
Dec. 12, 2016 (DE) 10 2016 224 746.8

(51) Int. Cl. B60R 25/00; B60R 25/25; B60R 25/24; B60R 25/04; E05B 81/64

(52) U.S. Cl. CPC B60R 25/003; B60R 25/252; B60R 25/255; E05B 2035/009; B60R 25/245; B60R 25/04; E05B 81/64; B60R 25/257

(57) ABSTRACT

Access and/or starting device for a vehicle An access and/or starting apparatus (ZSV) for a vehicle (FZ) has the following features. It comprises a biometric sensor device (BS; BS1-BS4, BSI) for detecting a biometric feature (GE) of a user; a position determining device (ZGS) for determining the position of an identification transmitter (IDG1, IDG2) assigned to the user (BU); a control device (STG) for enabling a vehicle function if the biometric feature of the user that is detected by the biometric sensor device (BS; BS1-BS4, BSI) corresponds to a predetermined feature and, the position determining device (ZGS) detects the identification transmitter in a predetermined region (ANB) around or in the vehicle (FZ). The security of the access and/or starting apparatus is increased in this way.

The present invention relates to an access and/or starting apparatus for a vehicle, in particular for a motor vehicle. Furthermore, the invention relates to a vehicle comprising a correspondingly stated access and/or starting apparatus.

In order to prevent unauthorized access to a vehicle, in particular motor vehicle, modern access authorization systems or access apparatuses in vehicles use electronic security systems in which, in order to authenticate the user, a data communication takes place between a first communication device of the vehicle and a second communication device in a mobile identification transmitter of the user, such as a key or key fob. In this case, the mobile identification transmitter in an active access apparatus transmits control signals and an identification code to the vehicle, for example as a result of an appropriate key being pressed by the user of the mobile identification transmitter, after which the vehicle is unlocked or locked if the identification code is correct.

In the case of a so-called passive access apparatus, firstly a first communication device of the vehicle firstly emits, at predetermined regular time intervals, radio signals as interrogation signals or localization signals with a specific field strength in order to check whether a mobile identification transmitter is located in an approach range around the vehicle. If a mobile identification transmitter is approaching the vehicle and can finally receive its interrogation signals because it has entered the approach range, it will respond to the reception of an interrogation signal in order to initiate an authentication process and in order to be able to determine the position of the mobile identification transmitter with respect to the vehicle. For the authentication, data messages are exchanged in which ultimately the mobile identification transmitter communicates its identification code to the vehicle. If the authentication code is checked successfully, it is then possible for a user who is located directly at the vehicle to initiate unlocking of the corresponding vehicle door or of all the vehicle doors by actuating a door handle. Since this requires no active actuation of a mechanical or electrical identification transmitter or of a key to be performed by a user, this type of access authorization is also referred to as a passive entry authorization check, and the corresponding access apparatuses are referred to as passive electronic access apparatuses.

In the case of the access apparatuses just described, however, there is the disadvantage that a thief with a purloined identification transmitter can easily get into the vehicle and possibly purloin it as well.

Consequently, the object of the present invention is to provide a possibility of increasing the security of a vehicle vis-à-vis anti-theft protection.

In accordance with a first aspect of the invention, an access and/or starting apparatus for a vehicle having the following features is provided. It has a biometric sensor device for detecting a biometric feature of a user. Furthermore, it has as position determining device for determining the position of an identification transmitter assigned to the user. Finally, it has a control device for enabling a vehicle function (in particular security relevant vehicle function) if the biometric feature of the user that is detected by the biometric sensor device corresponds to a predetermined feature, and the position determining device detects the identification transmitter in a predetermined region around or in the vehicle. As a result of this checking of two different and independent parameters, the anti theft protection of the vehicle is significantly increased.

In accordance with one configuration of the access and/or starting apparatus, the latter can furthermore comprise an authentication device for authenticating the identification transmitter, wherein the control device grants the enabling of the vehicle function if the authentication device has also authenticated the identification transmitter as correct. The security of the access and/or starting apparatus is increased further in this way since a third parameter, namely the authentication (in particular in the form of a communication of an identification code from the identification transmitter to the vehicle), is thus additionally added as well.

In accordance with one configuration of the access and/or starting apparatus, the vehicle function is starting the drive motor (MO) of the vehicle. In this context, the control device can grant the enabling of the motor starting if the position determining device detects the identification transmitter in an interior of the vehicle. It is also conceivable for the enabling to be granted only if the identification transmitter is recognized in a specific region of the interior, such as, for example, in the passenger compartment, or in the front row of seats in the passenger compartment (which also includes the driver's seat). Moreover, the biometric sensor device can comprise an internal sensor element in the vehicle interior, wherein the control device grants the enabling of the motor starting only if the internal sensor element has detected the biometric feature corresponding to the predetermined feature. This is intended to ensure that the motor can be started only by the person who has actually sat down in the interior of the vehicle (the passenger compartment) and thus also provided his/her biometric feature there.

In accordance with one configuration of the access and/or starting apparatus the latter furthermore has a first activation section, which activates the internal sensor element of the biometric sensor device in response to a first trigger signal. In this case, it is conceivable that the activation of the internal sensor element lasts only for a predetermined time interval. In this case, the first trigger device can activate the internal sensor element for the predetermined time duration, or the internal sensor element has a dedicated time measuring device, which ends again the activation of the internal sensor element for detecting a biometric feature of a user after the predetermined time interval. As a result of the provision of the first activation section, the biometric sensor device or the internal sensor element is activated only upon reception of the first trigger signal (and is not activated otherwise), with the result that power can be saved during operation of the access and/or starting apparatus in this way.

In accordance with one configuration, the access and/or starting apparatus furthermore comprises a door switch, which outputs the first trigger signal if it recognizes the opening of a door, in particular the vehicle door. In this way, the internal sensor element of the biometric sensor device is activated for example only if a user or driver opens the vehicle door and enters the passenger compartment.

In accordance with a further configuration, the access and/or starting apparatus comprises a second activation section, which activates the position determining device and/or the authentication device in response to a second trigger signal. In particular, it is possible in this case for the internal sensor element to output the second trigger signal after it has detected the biometric feature corresponding to the predetermined feature. In this regard, an automatic activation can be achieved. However, it is also conceivable for the access and/or starting apparatus furthermore to comprise a motor starting switch (e.g. a start/stop button), which outputs the second trigger signal upon actuation. In this case, it is conceivable for a prerequisite for outputting the second trigger signal upon actuation of the motor starting switch to be that the internal sensor element has previously detected the biometric feature corresponding to the predetermined feature. In this regard, a manual activation by a user can be achieved. As a result of the provision of the second activation section, the position determining device or the authentication device is activated only upon reception of the first trigger signal (and is not activated otherwise), with the result that power can be saved during operation of the access and/or starting apparatus in this way.

In accordance with one configuration of the access and/or starting apparatus the vehicle function is unlocking, opening, locking or closing of a closure device, such as a door of the vehicle. In this context, the control device can grant the enabling of the unlocking, opening, locking or closing of the closure device if the position determining device has detected the identification transmitter in a specific external region around the vehicle. It is also conceivable for the enabling to be granted only if the identification transmitter is in a specific range as far as a specific distance away from the vehicle. Moreover, the biometric sensor device can comprise an external sensor element at the exterior of the vehicle and an internal sensor element in the vehicle interior, wherein the control device grants the enabling of the unlocking, opening, locking or closing of a closure device if the external sensor element has detected the biometric feature corresponding to the predetermined feature.

In accordance with one configuration, the access and/or starting apparatus furthermore comprises a third activation section, which, in response to a third trigger signal, activates the external sensor element. In this case, the third trigger device can activate the external sensor element for the predetermined time duration, or the external sensor element has a dedicated time measuring device, which ends again the activation of the internal sensor element for detecting a biometric feature of a user after the predetermined time interval. In particular, in this case, the position determining device can output the third trigger signal if it detects the identification transmitter in a specific external region around the vehicle, or the authentication device outputs the third trigger signal if it has authenticated the identification transmitter as correct. It is also conceivable for the authentication device to output the third trigger signal only if the position determining device has previously detected the identification transmitter in a specific external region around the vehicle. As a result of the provision of the third activation section, the biometric sensor device or the external sensor element is activated only upon reception of the third trigger signal (and is not activated otherwise), with the result that power can further be saved during operation of the access and/or starting apparatus in this way.

It is also conceivable to combine the vehicle function for the unlocking, opening, locking or closing of a closure device (designated jointly as access process) with the motor starting by means of the external sensor element outputting the first trigger signal after it has detected the biometric feature corresponding to the predetermine feature. In this way, the position determining device and the internal sensor element are activated only when the access process is concluded. Consequently, once again power or energy can be saved.

In accordance with one configuration of the access and/or starting apparatus the biometric sensor device can be configured for recognizing as the biometric feature a facial image, a fingerprint, a handprint, an iris pattern, genetic information, a verbal behavior, a facial expression or a gait of a user.

As already indicated above, in particular in the case of a vehicle function for starting the drive motor in accordance with one configuration of the access and/or starting apparatus firstly the biometric sensor device can detect the biometric feature of the user, and then the position determining device can determine the position of the identification transmitter and/or the authentication device can carry out an authentication of the mobile identification transmitter only if the detected biometric feature of the user corresponds with the predetermined feature. In this way, it is possible to achieve an efficient checking of the parameters with reduced power consumption since firstly only one device is activated for determining a parameter, and only then in the event of successful checking is the second device activated.

Correspondingly, it is also conceivable that, in particular in the case of a vehicle function for access (such as for the unlocking, opening, locking or closing of a closure device), firstly the position determining device determines the position of the identification transmitter, and then the biometric sensor device detects the biometric feature of the user only in the event of the identification transmitter being detected in the predetermined region with respect to the vehicle (and if appropriate after a correct authentication of the mobile identification transmitter, the authentication device). In this case, too, an efficient checking of the parameters with reduced power consumption takes place since firstly only one device is activated for determining a parameter, and only then in the event of successful checking is the second device activated.

In accordance with a further aspect of the invention, a vehicle comprising an access and/or starting apparatus according to the above presentation or a configuration thereof is provided.

In accordance with a further aspect of the invention, provision is made of a method for operating an access and/or starting apparatus for a vehicle comprising the following steps. A biometric feature of a user is detected. Furthermore, the position of an identification transmitter assigned to the user is determined. Finally, a vehicle function is enabled if the detected biometric feature of the user corresponds to a predetermined feature, and the identification transmitter is detected in a predetermined region around or in the vehicle.

Advantageous configurations of the arrangements, in so far as applicable to the vehicle and the method, should also be regarded as advantageous configurations of the vehicle and of the method, and vice versa.

Exemplary embodiments of the present invention will now be explained in more detail below with reference to the accompanying drawings. In the figures:

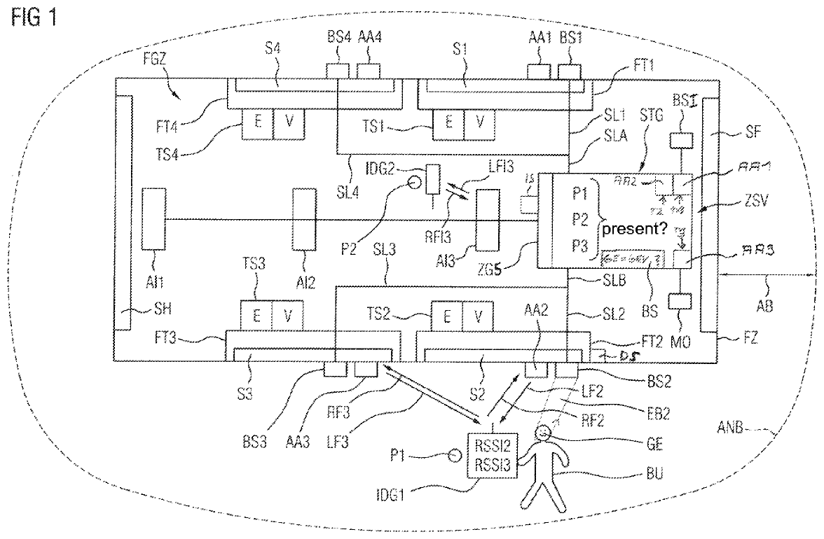

FIG. 1 shows a schematic illustration of a vehicle comprising an access and/or starting apparatus in accordance with one embodiment of the invention.

Reference shall be made to FIG. 1, which shows a schematic illustration of a vehicle FZ with the essential components of an access and/or starting apparatus in accordance with one embodiment of the invention. In this case, the vehicle FZ has a passenger compartment FGZ bounded by a plurality of transparent windows S1, S2, S3, S4, SH and SF. The rear window SH is provided at the rear end of the vehicle, while a windshield SF is provided at the front end. The other windows S1, S2, S3 and S4 are respectively assigned to corresponding vehicle doors FT1, FT2, FT3 and FT4. Correspondingly, the vehicle doors FT1-FT4 mentioned also bound the passenger compartment FGZ. The vehicle doors furthermore comprise respective door locks TS1, TS2, TS3 and TS4 assigned thereto, which can be brought to an unlocked state E and a locked state V by electrical driving.

The vehicle FZ furthermore has an access and starting apparatus, the central control component of which in the form of a position determining device ZGS is accommodated in a control device or controller STG. The access and starting apparatus ZSV is operated in particular in a so called passive mode, in which (controlled by the position determining device ZGS) firstly a first communication device (the antennas AA2, AA3) of the vehicle FZ emits at regular time intervals interrogation signals LF2, LF3 (in particular in the form of low frequency radio signals) having a specific field strength in order to check whether a mobile identification transmitter IDG1 is situated in a proximity region or detection region around the vehicle FZ. The mobile identification transmitter can be, in particular, an electronic key or key fob that is portable or able to be carried by the user.

To put it more precisely, for determining the position of the identification transmitter IDG1 with respect to the vehicle, the interrogation signals LF2 and LF3 having a predetermined field strength are emitted by the antennas AA2 and AA3 (also by the antennas AA1 and AA4, of course, wherein only the antennas AA2 and AA3 are discussed for reasons of simple explanation). Correspondingly, at the location P1 of the identification transmitter IDG1, the received field strength of said interrogation signals is measured and a corresponding received field strength value (RSSI=received signal strength indicator−value) RSSI2 for the signal LF2 and RSSI3 for the signal LF3 are determined. The measured received field strength values are then transmitted in each case as a response to the corresponding interrogation signals, by means of respective response signals RF2 and RF3, back to the antennas AA2 and AA3 for analysis by the position determining device ZGS. Said received field strength values permit a conclusion to be drawn about the distance or spacing of the identification transmitter IDG1 relative to the respective antennas AA2 and AA3. In accordance with FIG. 1, on account of the greater proximity of the identification transmitter IDG1 to the antenna AA2, the corresponding received field strength value RSSI2 will be greater than the received field strength value RSSI3. As a result of the corresponding correlation of the two received field strength values, it is thus also possible to determine the position of the identification transmitter IDG1.

In this case, an access process can proceed as follows. If a mobile identification transmitter approaches the vehicle and is finally able to receive the interrogation signals thereof, it can respond to the reception of a respective interrogation signal LF2 and LF3 in order furthermore also to initiate an authentication process. In this case, data messages are exchanged in which the mobile identification transmitter IDG1 ultimately communicates its specific code or identification code to the vehicle in an in particular radio frequency signal RF2 and RF3, respectively.

Besides the use of low frequency radio signals (e.g. at 125 kHz) as the interrogation signals LF2, LF3, it is also conceivable for the first communication device of the vehicle FZ to emit at regular time intervals interrogation signals LF2, LF3 in the form of radio frequency radio signals such as in accordance with a Bluetooth or WLAN (Wireless Local Area Network) standard for the position determination. This can be advantageous, in particularly, if the mobile identification transmitter is a cellular phone or smartphone (intelligent telephone) which is able to be carried by a user and which also comprises corresponding radio modules for receiving or else transmitting the radio frequency radio signals.

It should be noted that in the case of the above explanation for position determination between vehicle side antennas and the mobile identification transmitter, on the part of the mobile identification transmitter a received field strength measurement of low frequency (or radio frequency) localization signals, emitted by the vehicle side antennas, has been carried out. However, it is also conceivable to carry out a position determination between vehicle side antennas and the mobile identification transmitter on the basis of propagation time measurements, such as e.g. by means of radio based UWB (ultra wideband) transmissions.

To that end, the position determining device has instead of the abovementioned antennas for emitting low frequency (or high frequency) interrogation signals one or more corresponding UWB transmitting/receiving devices, to which respective UWB antennas are assigned. For a position determination with respect to the antennas, which are provided at different positions at the vehicle FZ depending on the application, the respective antennas emit UWB signals (short UWB pulses) to the mobile identification transmitter, which are received by the mobile identification transmitter and transmitted again back to the UWB antennas or the UWB transmitting/receiving devices assigned thereto. The propagation time required for overcoming the distance between the vehicle or the UWB antennas and the mobile identification transmitter is thus measured in the respective UWB transmitting/receiving devices, such that the respective distance or the relative position of the external transceiver with respect to the UWB antenna(s) can be ascertained on the basis thereof. An authentication process can also be carried out in addition to the positon determination by means of UWB.

If, in the course of the above position determination, the identification transmitter IDG1 was localized at the position P1 which lies in a specific region (here the proximity region ANB) at a specific distance AB from the vehicle FZ or in particular adjacent to a specific vehicle door, such as the driver's door, in the external area of the vehicle FZ, then a first parameter P1 for the enabling of a vehicle function, here in the context of an access function with respect to unlocking the door locks TS1-TS4, is fulfilled. It is possible here that an authentication of the mobile identification transmitter IDG can be effected only after successful position determination in the correct region and thus the fulfilment of the first parameter P1. Said authentication can be carried out by a dedicated authentication device, or by the position determining device ZGS, when then serves as an authentication device. Upon successful checking of the authentication code (corresponding comparison with a stored code), a second parameter P2 for the enabling of the vehicle function is then fulfilled.

In accordance with the embodiment of the access and starting apparatus in FIG. 1, this apparatus furthermore has a biometric sensor device BS, which is also part of the controller STG. In this case, said biometric sensor device comprises four external sensor elements BS1 to BS4, which are arranged at the respective doors FT1 to FT4 and are connected to the biometric sensor device BS via lines SLA, SL1, SL4 and SLB, SL2, SL3, respectively. These four external sensor elements BS1 to BS4 are configured for detecting biometric features of a user BU situated outside the vehicle FZ. In FIG. 1, by way of example, the external sensor element BS2 is configured for detecting the face GE of the user BU as a biometric feature in its detection region EB2. If said face GE corresponds to a face GEV that is predetermined or stored in the biometric sensor device BS, then a third parameter P3 for enabling the vehicle function of the unlocking of one or more of the door locks TS1-TS4 is present.

It is then conceivable that, in order to save power in the vehicle, the biometric sensor device or the four external sensor elements BS1 to BS4 are not activated continuously, but rather are activated only after the position determining device ZGS has detected the identification transmitter IDG1 in a specific external region (such as the proximity region ANB or a region adjacent to a vehicle door) around the vehicle FZ (that is to say that parameter P1 is present). It is also conceivable that the activation of the biometric sensor device or the four external sensor elements is effected after the authentication of the mobile identification transmitter has processed successfully (that is to say that parameter P2 is present), or if both conditions are present.

For this purpose, the controller STG can comprise an activation section AA3 for the biometric sensor device, said activation section activating a specific one or all of the external sensor elements BS1-BS4 in response to a trigger signal T3 for the biometric sensor device. In particular, it is possible for only the external sensor element which is closest to the determined position of the mobile identification transmitter to be activated. Furthermore, it is conceivable that the activation section AA3 activates the external sensor element(s) BS1-BS4 in particular only for a first predetermined time interval. If no biometric feature of a user was detected within said time interval, the external sensor element(s) BS1-BS4 is/are deactivated again in order further to save power at the vehicle.

The trigger signal T3 for the biometric sensor device can be output by the position determining device ZGS given the presence of the first parameter P1 (as mentioned above) or by the authentication device ZGS given the presence of the second parameter P2 if it has authenticated the identification transmitter as correct.

Given the presence of all three parameters P1, P2, P3 (or possibly only the parameters P1 and P3 depending on the configuration), the controller STG can then initiate unlocking of the corresponding door lock TS2 or of all the door locks TS1 to TS4 either directly or upon actuation of a door handle (not illustrated) by the user. As will be explained in even greater detail below, it is furthermore possible, given the presence of all three parameters P1, P2, P3 (or possibly only the parameters P1 and P3 depending on the configuration), after the end of the access process, for the controller STG also to output a first trigger signal T1.

The access and/or starting apparatus is then able to recognize not only objects (user and identification transmitter) situated in the exterior area for an access function, but also objects (user and identification transmitter) in the interior for enabling the motor starting. For the interior recognition, the position determining device ZGS is able, via antennas AI1, AI2 and AI3, by means of corresponding interrogation signals, to localize a mobile identification transmitter situated in the passenger compartment FGZ, such as the identification transmitter IDG2. A localization in the passenger compartment FGZ can then be effected in a manner corresponding to a localization outside the passenger compartment, as has already been explained above with regard to the identification transmitter IDG1. It is also conceivable that, for the purpose of localizing an identification transmitter, the individual antennas AI1-AI3, in the passenger compartment FGZ, emit only very short range interrogation signals, which can then be received only by an identification transmitter situated in the vicinity. In this way, it is conceivable that the passenger compartment FGZ can be classified into a plurality of zones in which an identification transmitter can be selectively located. In the case of FIG. 1, it shall be assumed that the mobile identification transmitter IDG2 is situated on the driver's side and, by means of interrogation signals LF13 on the part of the antenna AI3, is triggered to emit response signals RFI3.

In this way, the controller is again able to check a plurality of parameters also for enabling the motor starting. As a first parameter P1 for enabling the motor starting, it is possible here to use the position P2 of the identification transmitter IDG2, wherein this parameter is deemed to be fulfilled if said position is situated in the interior. As already explained above for the enabling of the unlocking, an effected authentication of the identification transmitter IDG2 vis a vis the vehicle FZ can serve as a second parameter P2. Said authentication can take place for example by means of an exchange of radio signals, such as the signals LFI3 and RFI3, via an interior antenna under the control also of the position determining device. Finally, by means of an internal sensor element BSI as part of the biometric sensor device BS, a biometric feature of a user situated in the vehicle can be detected in order to obtain a third parameter P3 for enabling the motor starting. As biometric feature, it is possible in this case to detect a fingerprint or likewise a face of the user who would like to start the drive motor MO in order to set off with the vehicle.

Given the presence of all three parameters P1, P2, P3 (or possibly only the parameters P1 and P3 depending on the configuration), the controller STG can then initiate a starting of the motor MO e.g. upon actuation of a motor starting button IS by the user. In the case, too, of realizing the vehicle function for starting the drive motor MO of the vehicle FZ, it is once again conceivable here to save power or energy in the vehicle by means of skillful successive activation of specific components of the access and/or starting apparatus.

In this regard, it is conceivable to provide a first activation section AA1 in the controller STG, said first activation section activating the internal sensor element BSI of the biometric sensor device BS in response to a first trigger signal Tl.

Said first trigger signal T1, as mentioned above, can be output by the controller after an access process has ended successfully. However, it is also conceivable for the first trigger signal T1 to originate from a door switch DS, which outputs the first trigger signal if it recognizes the opening of a door, in particular the vehicle door. If the door is opened, this is usually an indication that sometime very soon a user or driver will enter the passenger compartment, sit down on his/her seat and attempt to start the drive motor in order to drive away.

In order to further save energy and to increase security, it is conceivable that the activation of the internal sensor element lasts only for a specific time interval, and then the internal sensor element is deactivated again.

Furthermore, the controller STG can comprise a second activation section AA2, which activates the position determining device ZGS (and also the authentication device) in response to a second trigger signal T2. In this case, the internal sensor element BSI can output the second trigger signal T2 after it has detected the biometric feature corresponding to the predetermined feature. In particular, it is conceivable here that the biometric sensor device BS or the internal sensor element BSI is deactivated if it has detected the biometric feature corresponding to the predetermined feature (in order further to save power).

For outputting the second trigger signal, it is also conceivable that the access and/or starting apparatus furthermore comprises a motor starting switch or motor starting button IS, which outputs the second trigger signal upon actuation by a user.

Finally, the control device STG will grant the enabling of motor starting if the position determining device ZGS has detected the (in particular authenticated) identification transmitter IDG2 in an interior FGZ of the vehicle FZ (after a correct biometric feature of a user has been detected by the internal sensor element BSI).

1. An at least one of access and/or starting apparatus for a vehicle, comprising:
biometric sensor device configured to detect a biometric feature of a user;
a position determining device configured to determine a position of an identification transmitter assigned to the user;
a control device configured to enable a vehicle function if the biometric feature of the user detected by the biometric sensor device corresponds to a predetermined feature, and
if the position determining device detects the identification transmitter in a predetermined region around or in the vehicle.

2. The g apparatus as claimed in claim 1, further comprising:
an authentication device configured to authenticate the identification transmitter, wherein the control device grants the enabling of the vehicle function if the authentication device has also authenticated the identification transmitter as correct.

3. The apparatus as claimed in claim 1, wherein the vehicle function is starting a drive motor of the vehicle.

4. The apparatus as claimed in claim 3, wherein the biometric sensor device comprises an internal sensor element for detecting a biometric feature in the vehicle interior.

5. The apparatus as claimed in claim 4, further comprising:
a first activation section, which activates the internal sensor element in response to a first trigger signal.

6. The apparatus as claimed in claim 5, wherein the activation of the internal sensor element lasts only for a predetermined time interval.

7. The apparatus as claimed in claim 5, further comprising:
a door switch, which outputs the first trigger signal if it recognizes the opening of a vehicle door.

8. The apparatus as claimed in claim 4, further comprising:
a second activation section, which activates the position determining device in response to a second trigger signal.

9. The apparatus as claimed in claim 8, wherein the internal sensor element outputs the second trigger signal after it has detected the biometric feature corresponding to the predetermined feature.

10. The apparatus as claimed in claim 8, further comprising:
a motor starting switch, which outputs the second trigger signal upon actuation.

11. The apparatus as claimed in claim 2, wherein the control device grants the enabling of the motor starting if the position determining device detects the identification transmitter in an interior of the vehicle.

12. The apparatus as claimed in claim 1, wherein the vehicle function is at least one of unlocking, opening, locking and closing of a closure device.

13. The apparatus as claimed in claim 12, wherein the control device grants the enabling of the unlocking, opening, locking or closing of the closure device if the position determining device detects the identification transmitter in a specific external region around the vehicle.

14. The apparatus as claimed in claim 12, wherein the biometric sensor device comprises an external sensor element configured to detect a biometric feature at the exterior of the vehicle.

15. The apparatus as claimed in claim 14, further comprising:
a third activation section, which, in response to a third trigger signal, activates the external sensor element only for a specific time interval.

16. The apparatus as claimed in claim 15, wherein the position determining device outputs the third trigger signal if at least one of the position determining device detects the identification transmitter in a specific external region around the vehicle, and if the position determining device has authenticated the identification transmitter as correct.

17. The apparatus as claimed in claim 14, wherein the external sensor element outputs the first trigger signal after it has detected the biometric feature corresponding to the predetermined feature.

18. The apparatus as claimed in claim 1, wherein the biometric sensor device is configured to recognize as the biometric feature at least one of a facial image, a fingerprint, a handprint, an iris pattern, a DNA, a verbal behavior, a facial expression and a gait of a user.

19. The apparatus as claimed in claim 1, wherein one of
the biometric sensor device first detects the biometric feature of the user, and then the position determining device determines the position of the identification transmitter only in an event of the detected biometric feature of the user corresponding to the predetermined feature; and
the position determining device first determines the position of the identification transmitter, and then the biometric sensor device detects the biometric feature of the user only in an event of the identification transmitter being detected in at least one of the predetermined region around the vehicle and the vehicle.

20. (canceled)

21. (canceled)

22. A method for operating at least one of access and starting apparatus for a vehicle, comprising the steps of:
detecting a biometric feature of a user;
determining the position of an identification transmitter assigned to the user;
enabling a vehicle function if
the detected biometric feature of the user corresponds to a predetermined feature, and
the identification transmitter is detected in at least one of a predetermined region around the vehicle and the vehicle.
